(19) United States
(12) Patent Application Publication
(10) Pub. No.: US 2015/0000601 A1
(43) Pub. Date: Jan. 1, 2015

(54) MILKING MACHINE AND A METHOD OF OPERATING SUCH A MILKING MACHINE

(71) Applicant: Lely Patent N. V., Maassluis (NL)

(72) Inventor: Gerard Mostert, PA Maassluis (NL)

(73) Assignee: Lely Patent N.V., Maassluis (NL)

(21) Appl. No.: 14/378,701

(22) PCT Filed: Feb. 7, 2013
(86) PCT No.: PCT/NL2013/050068

§ 371 Date: Aug. 14, 2014

(30) Foreign Application Priority Data
Mar. 12, 2012 (NL) 2008465

(51) Int. Cl. A01J 5/017; A01J 5/06; A01J 9/00; A01J 5/04; A01K 1/12

(52) U.S. Cl. CPC A01J 5/0175; A01J 5/048; A01K 1/126; A01J 9/00; A01J 5/044; A01J 5/06
USPC 119/14.02; 119/14.43; 119/14.08; 119/14.03

(57) ABSTRACT

The invention relates to a milking machine comprising at least one teat cup, a milk conduit and a milk collecting container. The milking machine is arranged to repeatedly go through a teat searching phase and a milking phase. The milk conduit is with one end connected to an outlet of the teat cup and with an other end connected to the milk collecting container. The milking machine comprises a milking pump arranged to apply a predetermined and controlled vacuum to the milk conduit to transport milk from the teat cup via the outlet to the milk collecting container during the milking phase. The milking machine comprises a suction pump arranged to generate a suction flow through the teat cup towards and through the outlet during a teat searching phase.

### TECHNICAL FIELD

The invention relates to milking machine and a method of operating such a milking machine.

### PRIOR ART

Milking machines and robotic milking machines are known. Vacuum pumps form an important part of such milking machines in order to create a vacuum which is used to perform the milking and transporting the milk to a milk collecting container. Pumps may also be used for other purposes, such as teat cleaning and washing operations of the milking machine.

During milking, the level of vacuum should not be too high, to prevent injuring the animals, and may not be too low, as this may slow down the milking process. Also, the level of vacuum should be relatively constant in order to comply with regulations.

WO2006/006906 describes a milking system comprising a set of automatic milking machines, wherein each milking machine in the set of milking machines may operate in separate operating modes including milking and equipment washing. The milking system comprises a set of controlled vacuum pumps, wherein each vacuum pump, in the set of vacuum pumps, may operate in separate pump operating modes. The milking system comprises conduits connecting the set of vacuum pumps to the set of milking machines, controllable valves provided in the conduits for connecting or disconnecting vacuum pumps, of the set of vacuum pumps, to milking machines in the set of milking machines, and a control system provided to control the operating mode for each vacuum pump in the set of vacuum pumps and to control the controllable valves. The pumps are used for different purposes, although different purposes may require different pump characteristics.

WO02/03780 describes a system for regulating the vacuum in equipment for milking milk animals. The system comprises a first centrifugal electro pump, a vacuum line and a sensor for measuring the vacuum in the vacuum line. A control board is provided which checks the vacuum level measured by the sensor. If the vacuum in the vacuum line is not sufficient for ensuring an optimal level, in spite of an increase up to the maximum value of the capacity of the first electro pump driver, the control board orders a first remote-control switch to operate a second electro pump. Besides modulating the first electro pump, the control board controls starting and turning off of a second electro pump.

WO2008/121051 describes the use of two or more variable speed vacuum pumps, wherein a first pump is used for creating a required vacuum and a second pump is started when the vacuum level requirement is such that the speed of the first pump reaches a threshold. Both pumps may be controlled in parallel, i.e. using the same control signal.

WO2008/127177 describes a milking system adapted to perform milking operations of animals as well as cleaning operations by circulating washing liquid. A first pump capacity is provided to transfer milk from an intermediate container to a milk tank and a second pump capacity is provided to circulate washing liquid. The second pump capacity is higher than the first pump capacity.

An example of a milking machine is for instance described in EP0645079A1. Milking machines comprise one or more teat cups in which a teat is to be positioned. Automatically locating and positioning the teat inside the teat cup is important for a reliable and fully automated functioning of the milking machine.

According to EP0645079A1 a teat cup is provided with a fixed house and a flexible inner wall provided inside the fixed house creating an interspace in between the fixed house and the inner wall. Via an opening and a line connected to the opening, a pulsating vacuum can be applied by a pulsation system, which gives rise to a pulsating vacuum in the interspace, which is required for milking. As a buffer for the milk to be collected, in the lower part of the teat cup there is present a buffer space. A line serving for milk removal is connected to this buffer space.

An air line is connected to the inside of the flexible inner wall near the upper end. The air line is connected to a suction system including a continuously sucking pump whose suction power is controllable. If a relatively high vacuum is applied to the air line, the teat cup functions like a mouthpiece of a vacuum cleaner. When the teat cup is moved underneath the udder, the teat cup can function as a searching device for locating the teats, and where a teat is in the vicinity of the suction mouthpiece, the relevant teat is drawn into the teat cup. During the search for a teat with the teat cup, the buffer space is shut off from the space by means of a valve, thus preventing dirt or other impurities from entering the buffer space and/or the other lines. According to this document, the teat cup requires three connections, one for pulsation, one for milk removal and one for searching.

### BRIEF DESCRIPTION

It is an object to provide an improved milking machine, wherein available pumps can be used in an efficient way. It is a further object to provide a milking machine with a relatively simple design that allows drawing a teat into the teat cup using an air flow.

According to an aspect there is provided a milking machine arranged to repeatedly go through a teat searching phase and a milking phase, and comprising at least one teat cup with an outlet, a milk collecting container, a milk conduit connecting the outlet of the teat cup and the milk collecting container, and a milking pump arranged to apply a predetermined and controlled vacuum to the milk conduit to transport milk from the teat cup via the outlet to the milk collecting container during the milking phase, wherein the milking machine comprises a separate suction pump arranged to generate a suction flow through the teat cup towards and through the outlet during a teat searching phase.

Both the suction pump and the milking pump thus pump through the same outlet of the teat cup.

The milking machine may go through different operating phases, such as a milking phase and a teat searching phase. In the milking phase the requirements for the vacuum and air flow are different from those in the teat searching phase. While a well-defined vacuum level with a relatively low air flow is required during milking, a relatively big air flow is useful during the teat searching phase while the exact vacuum level is of less importance.

By providing two different pumps, one for the milking phase and one for the teat searching phase, both pumps can be designed for their specific task. The milking pump for use during the milking phase is a regulated pump, of which the working speed and the created vacuum level can be regulated in an accurate way, while the suction pump for use during the teat searching phase can be a different type of pump which only needs to have two working states: on and off. The milking machine may be arranged to control the suction pump to be in one of the two working states (on or off) and is thus not arranged to control or regulate the exact working speed of the suction pump.

This way, the different pumps can be used in a more energy-efficient way. For example, the more complex and expensive regulated milking pumps can be made smaller, because they no longer need to be able to provide a high flow during a teat search phase. And by being able to thus select a smaller type of milking pump, energy and cost can be saved. The suction pump, which need only be on during a relatively short time as compared to the milking pump, may be a high-power but simple and unregulated pump. The high power ensures a relatively efficient searching, as the positioning of the teat cup with respect to the teat need not be extremely precise, while there is not much use of energy, for this pump only works during a short time per milking. Also, both the milking pump and the suction pump can be designed such that they are operated at or close to their optimal working state.

The milking pump is typically used at a vacuum level in the range of 40-50 kPa with an air flow of 100-200 l/min, while the suction pump is typically operated at an air flow of more than 800 l/min at atmospheric pressure, usually more than 1000 l/min, for instance in the range of 1000-1500 l/min. The controllable milking pump can now be designed to operate with a relatively small airflow, which allows using simple and cheap milking pumps, while the suction pump may be designed to operate with a relatively large air flow and can thus be a simple high throughput pump. It is also possible to use a suction pump that shows a pump characteristic in which the maximum flow versus pressure difference drops sharply. This means that, for this pump type, the flow may be large at atmospheric pressure, i.e. zero vacuum pressure, but as soon as a pressure difference builds up, the flow drops sharply. Alternatively, the pressure difference to be built up by the suction pump is advantageously low, in particular about 30 kPa or less. Note that this may be useful when connecting a teat to a teat cup, as a suction pump able to build up a very high pressure difference might cause pain to the animal. Rather, a smaller pressure difference is safer here, while the true and regulated milking vacuum can be built up by the milking pump. This also lessens the requirements for the suction pump, which may thus be made even simpler.

Both the controllable (milking) pump and the suction pump make use of one and the same connection between the milk conduit and the teat cup.

According to an embodiment wherein the milking machine is a robotic milking machine, comprising a teat position detection system and a robot arm arranged to connect the at least one teat cup to a teat under the control of the teat position detection system. This embodiment is advantageous as with robotic milking machines, connecting the teat to the teat cup can profit more from the assistance by the strong air flow, compared to manual milking where such high flow is not needed.

According to an embodiment the milking pump is a positive displacement pump, in particular a rotary vane pump or a piston pump. Such pumps are suitable for creating a well-defined vacuum level over a relatively large pressure range, simply by controlling the working speed of the pump, which can easily be done by a control unit.

According to an embodiment the suction pump is a turbo pump, preferably an unregulated turbo pump, having only an idle state and a single, non-regulated working state. In particular, the turbo pump may be an unregulated turbo pump, wherein the term unregulated is used to indicate that the milking machine may only be arranged to control the suction pump to be in an on-or-off state, i.e. in an idle or working state. Examples of turbo pumps are a centrifugal pump and an axial flow pump. Such pumps are suitable for purposes in which a high flow rate is important, while the vacuum level is of less importance, such as is the case during the teat searching phase.

According to an embodiment the milking machine comprises a control unit arranged to
control the working speed of the milking pump, and
control the suction pump to be in one of an idle state and a preferably non-regulated working state.

The milking pump is thus a controllable or regulated pump, i.e. the working speed of the milking pump can be regulated in order to create and maintain the predetermined vacuum to the milk conduit. As this is not necessary for the suction pump used during the teat searching phase, the control unit controls the suction pump to be in one of an idle state or a working state. In the working state the working speed of the suction pump is not regulated by the control unit.

According to an embodiment the milking machine comprises a pressure sensor to measure the pressure in one of the teat cup, the outlet or the milk conduit. Such a pressure sensor can be used during the milking phase to prevent the pressure from becoming too high or too low. The control unit may be arranged to create control signals for the milking pump to control the milking pump to create and maintain the predetermined vacuum level during milking. The vacuum level may be monitored and the milking pump may be controlled to maintain the predetermined vacuum level based on the monitored pressure or vacuum level.

According to an embodiment the milking machine comprises a teat presence sensor arranged to detect the presence of a teat inside the teat cup and to provide a teat presence detection signal and the milking machine is arranged to switch off the suction pump and/or disconnect the suction pump from the teat cup on the basis of the teat presence detection signal. The teat presence sensor may be an optical sensor located in the teat cup. Alternatively, the teat presence sensor may be a pressure sensor, such as the pressure sensor described above. Once a teat is drawn into the teat cup, the pressure in the teat cup, the outlet, the milk conduit and/or the suction conduit suddenly drops, which may be sensed by the pressure sensor. Any other teat detection or teat cup connection device may be used.

The teat searching phase may end once presence of a teat is detected or once presence of teats in all associated teat cups is detected. Note that, in case there is either too much air flow due to incorrect teat cup connection or due to premature teat cup disconnection, such as due to kicking or the like, it may be decided to reattach the teat cup. In that case, the milking phase is yet again followed by a teat searching phase, in which the suction pump may again assist.

The pressure sensor may be arranged to communicate with the control unit. Once a pressure drop is detected, the control unit may switch off the suction pump or disconnect the suction pump from the teat cup. This last option may be advantageous in case the suction pump is still to be used for other teat cups. The control unit may also be arranged to switch off the suction pump or disconnect the suction pumps from all teat cups associated with a single animal, once the presence of teats is detected in all teat cups associated with that animal.

According to an embodiment the milking pump can be controlled to generate a predetermined vacuum level in the range of 35-55 kPa with an airflow in the range of 100-200 l/min. With such a pressure and air flow, milking can be performed reliably and efficiently. Lower airflows are not excluded, and could theoretically be almost as low as the milk flow from the one or more teat cups for which the milking pump is to deliver the vacuum, such as 5-10 l/min.

According to a further embodiment the suction pump is arranged to generate an airflow of at least 800 l/min, preferably at least 1000 l/min, more preferably in the range of 1000-1500 l/min. With such an air flow, a reliable sucking in of the teat may be ensured. The vacuum level as defined is the vacuum level inside the teat cup. The airflow ranges relate to substantially atmospheric pressure, while it is allowed for the airflow to fall off substantially when a pressure difference builds up, in other words when a vacuum is being created within a teat cup.

According to regulations, a predetermined vacuum level within specific margins is to be maintained during the whole milking phase, even while the circumstances may change during the milking phase. For instance, the controllable milking pump may be shared with other teat cups in the same milking machines, or with other milking machines, which may for instance be idle, in a milking phase or in a cleaning phase etc., resulting in a varying demands on the milking pump. It is also noted that varying the vacuum level as a function of the milking phase is not excluded, as long as the actual level does not vary too much from the momentarily desired vacuum level during the relevant milking phase.

According to an embodiment the suction pump is connected to the outlet via the milk conduit and the milk collecting container. This embodiment can relatively easily be incorporated.

According to an embodiment the milking machine comprises a branching positioned in between the outlet and the milk collecting container, arranged to switch between a first and a second mode, wherein in the first mode the outlet is connected to the milk collecting container and the milking pump via the branching and in the second mode the outlet is connected to the suction pump via the branching. Valves may be provided and controlled to switch between the first and second mode.

In the second mode, the outlet is connected to the suction pump directly, i.e. not via the milk collecting container.

The milking machine may be arranged to switch to the first mode during the milking phase and to the second mode during the teat searching phase.

This embodiment has the advantage that during the teat searching phase, the suction flow generated by the suction pump does not flow through the milk collecting container, thereby reducing the risk of possible contamination of the milk collecting container.

The branching may be positioned at any position in the milk conduit, but may also be positioned in between the outlet and the milk conduit or in between the milk conduit and the milk collecting container. The branching and the valves may be combined in a three-way valve.

According to an aspect there is provided a method of operating a milking machine preferably as described above, wherein the milking machine is arranged to repeatedly go through a teat searching phase and a milking phase,

wherein in the milking phase the method comprises:
controlling a milking pump to apply a predetermined vacuum to a milk conduit to transport milk from a teat cup via an outlet of the teat cup and the milk conduit to a milk collecting container,

and wherein in the teat searching phase the method comprises:
controlling a suction pump to generate a suction flow through the teat cup towards and through the outlet and suction pump.

According to an embodiment in the teat searching phase the method further comprises
detecting presence of a teat inside the teat cup using a teat presence sensor and to provide a teat presence detection signal and
switching off the suction pump or disconnecting the suction pump from the teat cup on the basis of the teat presence detection signal.

According to an embodiment in the milking phase the method further comprises
controlling the working speed of the milking pump during the milking phase and
controlling the suction pump to be in one of an idle state and a preferably non-regulated working state.

According to an embodiment the method further comprises measuring a pressure in one of the teat cup, the outlet or the milk conduit and controlling the working speed of the milking pump in response to the measured pressure during the milking phase.

According to an embodiment the method further comprises controlling the milking pump to generate a predetermined vacuum level in the range of 35-55 kPa with an airflow in the range of 100-200 l/min during the milking phase, and controlling the suction pump to generate an airflow of at least 800 l/min during the teat searching phase, preferably of at least 1000 l/min, more preferably in the range of 1000-1500 l/min.

It is also possible to combine the advantages of the invention into a milking arrangement with more than one milking machine. Therefore, the invention also relates to milking arrangement comprising a plurality of milking machines according to the invention and in particular each comprising at least one teat cup with an outlet, a milk collecting container, a milk conduit connecting the outlet of the teat cup and the milk collecting container, the milking arrangement further comprising a milking pump arranged to apply a predetermined and controlled vacuum to the milk conduit of at least one of the milking machines to transport milk, for that milking machine, from the teat cup via the outlet to the milk collecting container during the milking phase, characterized in that the milking arrangement comprises at least one separate suction pump arranged to generate for at least two of the milking machines a suction flow through at least one teat cup towards and through the respective outlet during a teat searching phase of the respective milking machine. Because the separate suction pump is only operative for each milking machine during a short period of each milking, it may be operative for more than one milking machine in the arrangement. It is also easily feasible to lay out the suction pump as a high throughput pump for more than one milking machine. In particular, the suction pump may be arranged to be operatively connectible to at least one teat cup of at least two milking machines. In an embodiment, this may be achieved by providing a number of ducts connected to each of the milk conduits and to the suction pump, each of the ducts provided with a controllable valve. It is possible to arrange the ducts separately between each milk conduit and the pump, or to, optionally repeatedly, combine two or more ducts into one duct, for example a number of ducts equal to the number of milking machines, each of the ducts branching into four sub-ducts, each connected to one milking cup. Of course, each sub-duct will have its own controllable valve. In an embodiment, the milking arrangement may be arranged as a milking carrousel, typically comprising from about a dozen to a few tens of milking machines.

### SHORT DESCRIPTION OF THE DRAWINGS

Embodiments will now be described, by way of example only, with reference to the accompanying schematic drawings in which corresponding reference symbols indicate corresponding parts, and in which:

FIG. 1 schematically shows part of a milking machine according to the state of the art,

FIG. 2 schematically shows an embodiment;

FIG. 3 schematically shows an alternative embodiment;

FIG. 4 shows a pump characteristic diagram for a prior art pump; and

FIG. 5 shows pump characteristic diagrams for pumps in the present invention.

### DETAILED DESCRIPTION

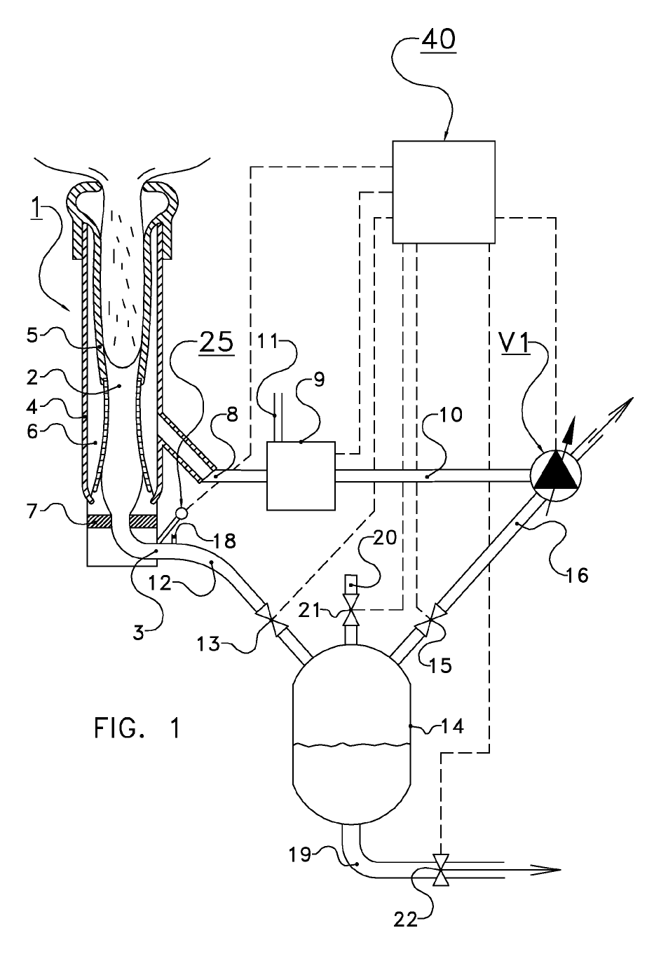

FIG. 1 shows part of a milking machine comprising at least one teat cup 1. It will be understood that the teat cups may be provided on a robot arm construction (not shown) of a (robotic) milking machine or milking robot. The robot arm construction comprises a carrier for carrying a suitable number of teat cups, for instance two or four.

The teat cup 1 shown in FIG. 1 comprises an outer casing 4 and a teat cup liner 5 which is made from a flexible material. The teat cup liner 5 is positioned inside the outer casing 4 with the upper part of the teat cup liner 5 being positioned over an upper edge of the outer casing. Between the outer casing 4 and the teat cup liner 5 there is located a pulsation chamber 6, which is on its lower side closed by a flange 7. A further perforated flange (not shown) may be provided above flange 7 to hold the teat cup liner 5 in position. This further flange may be provided with openings.

The inside space of the teat cup liner 5 is referred to as the teat space 2. During a milking phase, a teat is positioned inside teat space 2 as shown in FIG. 1 by the dashed line. The teat cup liner 5 has a tapered shape which narrows towards the bottom of the teat cup 1.

In use, a vacuum and an atmospheric pressure are alternately applied to the pulsation chamber 6 to thereby move the teat cup liner 5 in a pulsating manner. A pulse conduit 8 is connected to the pulsation chamber 6. The pulse conduit 8 may be connected to a pulsator 9. The pulsator 9 may be connected to a pump, in this example to a milking pump V1 via a conduit 10 and may further comprise an atmospheric inlet 11. The pulsator 9 may for instance be formed as a three way valve which alternatingly connects the pulse tube 8 to the atmospheric inlet 11 and to the milking pump V1 via conduit 10 to alternatingly apply vacuum and atmospheric pressure to the pulsation chamber 6. The pulsator 9 may be controlled by a computer or control unit 40 (described below).

Near the lower side of the teat cup 1 there is provided a milk conduit 12 which is with a first end connected to an outlet 3 of the teat cup 1. The lower narrow side of the teat cup liner 5 is connected to the outlet 3. In between the lower narrow side of the teat cup liner 5 and the outlet 3, a corner piece (not shown) may be provided to connect the teat cup liner 5 to the outlet 3.

The milk conduit 12 is with its other end connected to a milk collecting container 14. The milk conduit 12 is provided to transport milk from the teat cup liner 5 via the milk outlet 3 to the milk collecting container 14. A valve 13 may be provided in the milk conduit 12.

Further provided is a conduit 16 which connects the milking pump V1 to the milk collecting container 14. Conduit 16 is connected to a top part of the milk collecting container 14 to prevent milk from being sucked into the milking pump V1. Conduit 16 may comprise a valve 15. By opening valves 13 and 15 and switching on the milking pump V1 milk can be transported from the teat cup liner 5 into the milk collecting container 14 via milk conduit 12. Milking pump V1 is arranged to pump air which draws the milk into the milk collecting container 14. The conduit 12 may therefore comprise an air inlet 18 to ensure the supply of sufficient amounts of air.

The milk collecting container 14 may further comprise an air inlet 20 at the upper part of the milk collecting container 14. The air inlet 20 comprises a valve 21.

A milk transport conduit 19 may be provided at the lower part of the milk collecting container 14 to transport the milk from the milk collecting container 14 for further processing. The milk transport conduit 19 comprises a valve 22. When transporting milk from the milk collecting container via the milk transport conduit 19, valves 21 and 22 are opened.

A control unit 40 may be provided to control the milking pump V1, the pulsator 9 and the valves 13, 15, 21, 22. The control unit 40 may be a computer comprising a central processing unit and a memory, the memory comprising programming lines readable and executable by the central processing unit to provide the control unit 40 with the functionality in accordance with the embodiments described. Alternatively, the control unit 40 may be a hardware device dedicated to the functionality in accordance with the embodiments described.

In the Fig.'s the control unit 40 is shown to be connected to different parts of the milking machine, the connection being indicated by dashed lines. The dashed lines indicate that the connected items are arranged to communicate with each other (in a one-way or two-way manner). The communication may be wired or wireless.

Although FIG. 1 shows a single teat cup 1, it will be understood that a plurality of teat cups, usually four, are provided in association with each other to milk an animal. Milk conduit 12 may for instance split into four branches, each branch being connected to a different teat cup 1. Also, instead of one, two or more milk collecting containers 14 with associated teat cups 1 may be connected to the milking pump V1.

### Milking Pump

The milking pump V1 may be a positive displacement pump, such as a rotary vane pump or a piston pump.

A positive displacement pump will produce a substantially fixed flow at a given working speed, irrespective of the pressure. The milking pump V1 may be powered by a suitable engine, such as an electromotor or an internal combustion engine (not shown).

The milking pump V1 is a regulated pump, i.e. the working speed of the milking pump V1 can be regulated by the control unit 40 in an accurate way to keep the vacuum level in the teat space 2 at a predetermined level in the range of 40-50 kPa, for instance at 43 kPa. The milking pump V1 may be controlled by control unit 40.

The vacuum level created by the milking pump V1 can be applied to the milk conduit 12 to transport milk from the teat cup 1, i.e. from the teat space 2 through the outlet 3 to the milk collecting container 14. Milking pump V1 may be controlled in an accurate way to create and maintain a predetermined vacuum level and work with a relatively low air flow of less than 200 l/min for four teat cups, for instance 150 or 100 l/min. An air inlet 18 may be provided to allow air to enter. The air inlet 18 may be provided in the milk conduit 12 or in the teat cup 1.

Positive displacement pumps are also suitable for being controlled to create a well-defined vacuum level.

In order to create and maintain the vacuum level at the predetermined level a pressure sensor 25 may be provided, which is arranged to provide pressure readings to control unit 40. The control unit 40 may be arranged to provide control signals to the milking pump V1 in response to the pressure readings received from the pressure sensor 25.

In use, the milking machine may repeatedly go through different operation phases, such as
a teat searching phase in which the teat cup 1 is moved, for instance by the robot arm, to position the teat inside the teat cup 1, and
a milking phase in which a teat is inside the teat cup 1 and the actual milking takes place.

During the teat searching phase, optical devices, such as lasers and sensors, may be used to detect the teats and determine an estimated position of the teats and control the movements of the teat cup 1 accordingly during the teat searching phase.

Of course, the milking machine may be go through further phases, such as a milking machine cleaning modus, a teat cleaning modus, etc.

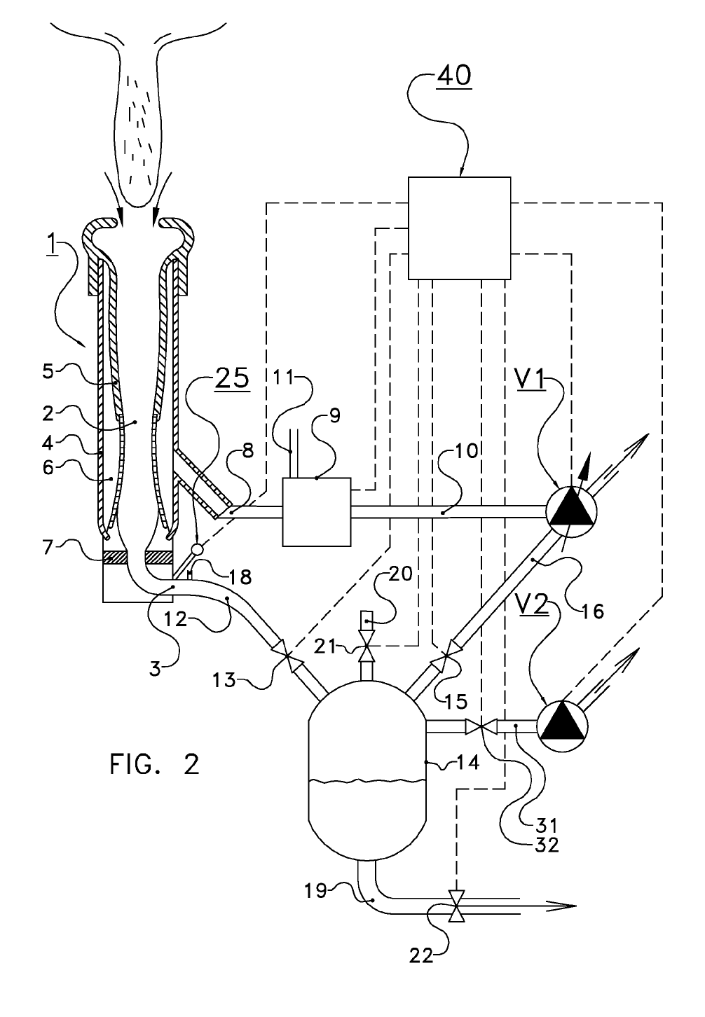

During the teat searching phase a relatively large suction flow is generated through the teat cup 1 to suck a nearby teat into the teat space 2. The suction air flow may be 1000-1500 l/min. In order to do this, a suction pump V2 is provided as shown in FIG. 2.

As shown in FIG. 2, the suction pump V2 may be connected to the milk collecting container 14 via a conduit 31, which may comprise a valve 32. According to this embodiment, the suction flow is sucked into the teat cup 1, through the outlet 3, the milk conduit 12, the milk collecting container 14, the conduit 31 towards the suction pump V2.

Of course, the suction pump V2 may also be provided at different locations, the suction pump V2 may for instance be directly connected to the milk conduit 12 via a three-way valve, by-passing the milk collecting container 14. The three-way valve may be controlled to connect the outlet 3 to the suction pump V2 during the teat searching phase or to the milking pump V1 during the milking phase. The suction pump V2 is connected to the valve 34 via a suction conduit 33. The three-way valve may be provided half way the milk conduit 12, for instance upstream of valve 13, but the three-way valve may also be positioned in between the outlet 3 and the milking conduit 12. The suction pump V2 may be connected to the three-way valve via suction conduit 33.

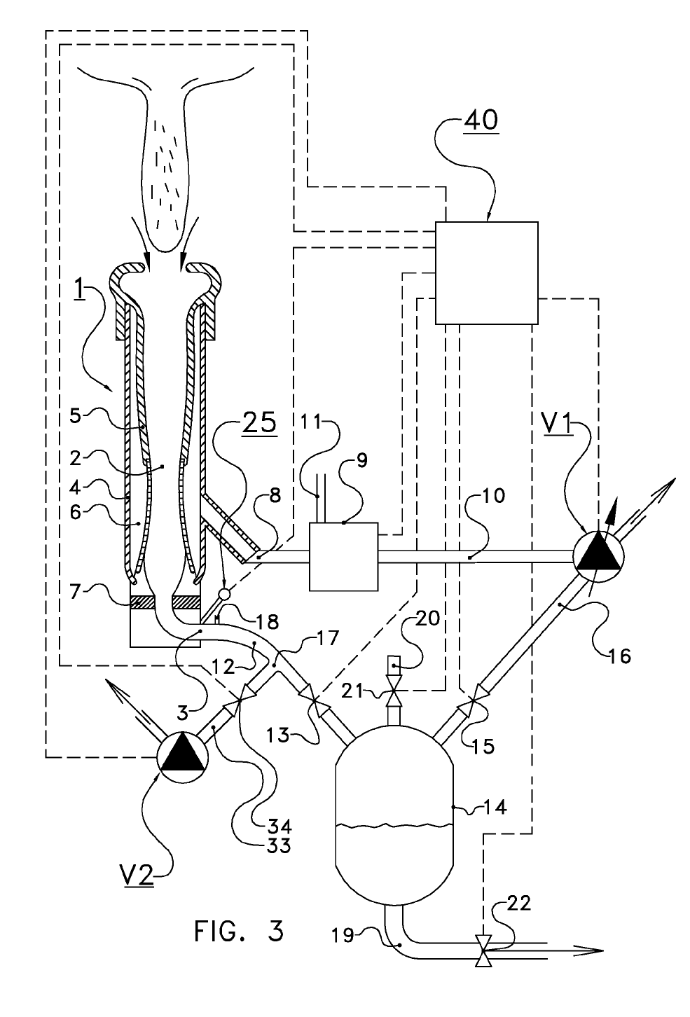

By providing such a three-way valve in between the teat cup and the milk collecting container, which three-way valve in a first state connects the teat cup to the milk collecting container 14 and the milking pump V1 via outlet 3, and in a second state connects the teat cup 1 to the suction pump V2 via outlet 3 but not via the milk collecting container 14, dirt is prevented from entering the milk collecting container 14 during the teat searching phase. The three-way valve may be controlled to switch from the first state to the second state by the control unit 40 when the milking machine starts the teat searching phase and to switch from the second state to the first state at the end of the teat searching phase. An example of such an embodiment will be described in more detail below with reference to FIG. 3.

### Suction Pump

The suction pump V2 may be suitable to create a relatively high air flow. The suction pump may for instance be a turbo pomp, such as a centrifugal pump or an axial flow pump. A turbo pump comprises rotating blades and is typically suitable for creating relatively high flow rates.

The suction pump V2 may be controlled by the control unit 40. The control unit 40 may switch on the suction pump V2 at the start of the teat searching phase and may switch off the suction pump V2 at the end of the teat searching phase. The milking machine or control unit 40 is not arranged to regulate the working speed of the suction pump other than switching the suction on and off. The suction pump V2 is thus an unregulated pump, i.e. the working speed of the suction pump V2 is not regulated.

The milking machine may comprise a teat presence sensor to determine whether or not a teat is present in the teat space 2. The teat presence sensor may be an optical sensor arranged to determine whether or not a teat is present in the teat space. Alternatively, the teat presence sensor may be a pressure sensor which is arranged to determine a pressure drop in the teat space 2, the outlet 3, the milk conduit 12 or the suction conduit 26. Such a pressure drop will occur once the teat is drawn into the teat space 2. Alternatively, the teat presence sensor may be a flow meter provided in the teat space 2, the outlet 3, the milk conduit 12 or the suction conduit 26 arranged to determine a decrease of the flow during the teat searching phase. Such a flow decrease will occur once a teat is present in the teat space 2 as the teat prevents the suction flow from flowing.

The teat presence sensor may detect the presence of a teat inside the teat cup and provides a teat presence detection signal. The teat presence detection signal may be generated by the teat presence sensor or may be generated by the control unit 40 based on measurements readings received by the control unit 40 from the teat presence sensor. The milking machine (control unit 40) is arranged to switch off the suction pump V2 and/or disconnect the suction pump V2 from the teat cup 1 on the basis of the teat presence detection signal. The milking machine may switch off or disconnect the suction pump V2 upon receipt of the teat presence detection signal or upon receipt of a predetermined number (e.g. four) of teat presence detection signals from different associated teat cups 1.

The suction pump V2 may be powered by a suitable engine, such as an electromotor or an internal combustion engine (not shown).

FIG. 3 shows an alternative embodiment of a milking machine. According to the embodiment shown in FIG. 3, the suction pump V2 is connected to the outlet 3 not via the milk collecting container 14.

As shown in FIG. 3, the milk conduit 12 may comprise a branching 17, with a first end connected to the outlet 3, a second end connected to the milk collecting container 14 and a third end connected to the suction pump V2. The branching may for instance be formed by a T- or Y-piece.

In between the branching 17 and the milk collecting container 14, valve 13 is provided. In between the branching 17 and the suction pump V2 a suction conduit 33 is provided in which a second valve 34 is provided.

Both valves 13, 34 are controlled by the control unit 40. The valves 13, 34 may be controlled by the control unit 40 to switch between a first mode and a second mode. In the first mode, the first valve 13 is open and the second valve 34 is closed. In the second mode, the first valve 13 is closed and the second valve 34 is open.

The control unit 40 controls the valves 13, 34 to be in the first mode during the milking phase to connect the outlet 3 to the milking pump V1 and in the second mode during the teat searching phase to connect the outlet 3 to the suction pump V2.

FIG. 3 shows the branching 17 at a position halfway the milk conduit 12. However, the branching 17 may be positioned at any suitable position along the milk conduit 12, including at the ends of the milk conduit 12, i.e. in between the outlet 3 and the milk conduit 12 and in between the milk conduit 12 and the milk collecting container 14.

It will be understood that the branching 17 and the valves 13, 34 may be combined into a three-way valve. In that case, the milking machine comprises a three-way valve positioned in between the outlet 3 and the milk collecting container 14, arranged to switch between the first and a second mode, wherein in the first mode the outlet 3 is connected to the milk collecting container 14 and the milking pump V1 and in the second mode the outlet 3 is connected to the suction pump V2, but not via the milk collecting container 14.

These embodiments have the advantage that during the teat searching phase, no suction flow is generated through the milk collecting container 14, thereby reducing the risk of contaminating the milk collecting container 14.

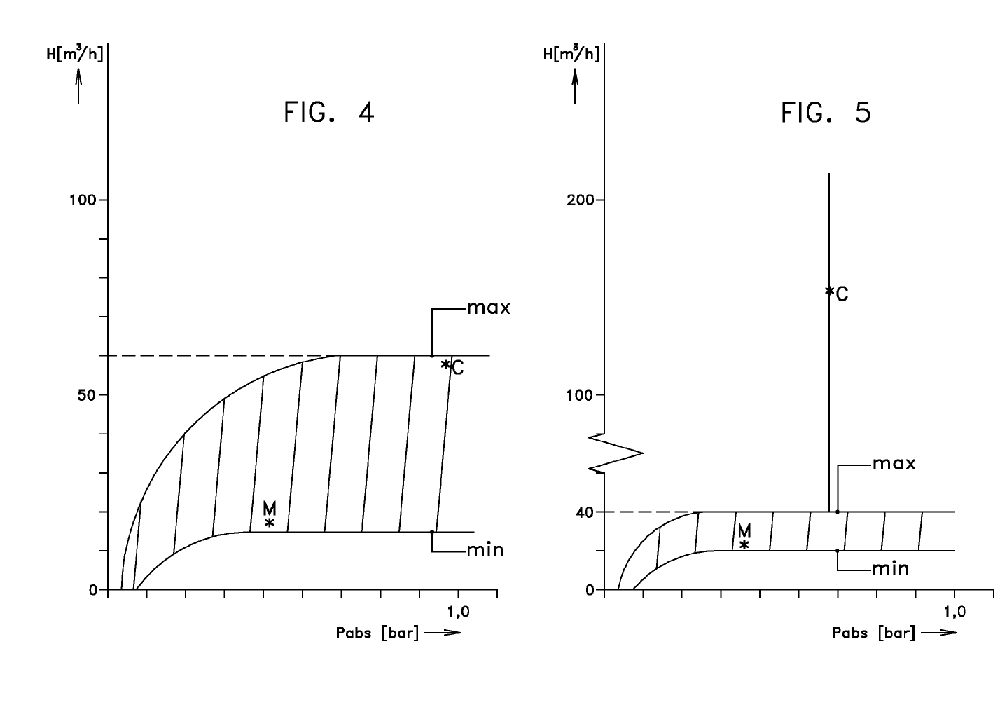

FIG. 4 shows a pump characteristic diagram for a prior art pump for a milking machine, with as usual the resultant flow H on the vertical axis, and the absolute pressure Pabs on the horizontal axis. Thus the pressure difference achieved by the pump equals (atmospheric pressure minus Pabs). The letter C indicates a situation when a teat cup is connected (teat searching phase), and the letter M indicates when the teat cups are all milking (milking phase). The hatched area denotes the range of values that can be reached with the selected pump, a Busch MM1104AV 1.1 kW, between a low speed (indicated as “min”) and nominal speed (indicated as “max”).

Such a pump has as a requirement that it is settable to achieve various (milking) vacua down to about 50 kPa, thus various Pabs from about 50-100 kPa. It must be able to do this at different flows, that arise from the flow of milk and controlled air leaks to transport the milk. In practice, such flows are of the order of 50 l/min. Thus, for a milking machine with four teat cups, this amounts to about 200 l/min, or with some margin up to about 15-20 m3/h. Note, however, that this relates to milking. In order to enable a reliable sucking in of a teat during the teat searching phase, a higher flow of up to 1.000 l/min, or 60 m3/h, is useful, although this need only be delivered for one teat cup at a time. But importantly, using one and the same pump for milking with a first teat cup, and for connecting a second teat cup already means that there are totally different working conditions, namely high flow and low vacuum for the second (teat searching phase), but low flow and relatively high vacuum for the first (milking phase). This by itself already means difficulties in regulating the various conditions for the various teat cups.

FIG. 5 shows pump characteristic diagrams for pumps in the present invention. Herein, again, the axes denote absolute pressure and air flow, while the letters C and M indicatively denote connecting a teat cup (teat searching phase) and milking four teat cups (milking phase).

It can be clearly seen that in this case the conditions are even more different, the connecting being carried out at a flow of more than 100 m3/h. What is more, the characteristics indicative of two pumps, one regulated pump at lower absolute pressure and flow values, and one non-regulated pump, in this case a Fluxjet 1.1 kW side channel vacuum pump, at high flow and high absolute pressure values. Furthermore, the non-regulated pump is a simple pump with a curve that falls off sharply as a function of built-up pressure difference. But this is not so relevant during teat connection, as the true milking vacuum value will be set by the regulated pump anyway.

The regulated pump can now be tailored to a smaller power, as the requirements are now limited to purely milking values, in this case up to 40 m3/h. Note that it is possible to lower it even further, down to about 15-20 m3/h as already mentioned in the discussion of FIG. 4. The present invention thus allows not only the selection of a much lower power regulated pump, but also prevents having to combine somehow a high flow, high pressure situation (connecting a subsequent teat cup) with a low flow, low pressure situation (milking a first teat cup). This allows a more stable milking vacuum for those teat cups already connected, or at least the maintaining a stable vacuum with simpler means.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-18. (canceled)

19. A milking machine arranged to repeatedly go through a teat searching phase and a milking phase, and comprising at least one teat cup with an outlet, a milk collecting container, a milk conduit connecting the outlet of the teat cup and the milk collecting container, and a milking pump arranged to apply a predetermined and controlled vacuum to the milk conduit to transport milk from the teat cup via the outlet to the milk collecting container during the milking phase, the milking machine comprises a separate suction pump arranged to generate a suction flow through the teat cup towards and through the outlet during a teat searching phase.

20. Milking machine according to claim 19, wherein the milking machine is a robotic milking machine, comprising a teat position detection system and a robot arm arranged to connect the at least one teat cup to a teat under the control of the teat position detection system.

21. Milking machine according to claim 19, wherein the milking pump is a positive displacement pump, in particular a rotary vane pump or a piston pump.

22. Milking machine according to claim 19, wherein the suction pump is a turbo pump, preferably an unregulated turbo pump, having only an idle state and a single, non-regulated working state.

23. Milking machine according to claim 19, wherein the milking machine comprises a control unit arranged to
control the working speed of the milking pump, and
control the suction pump to be in one of an idle state and a preferably non-regulated working state.

24. Milking machine according to claim 19, wherein the milking machine comprises a pressure sensor to measure the pressure in one of the teat cup, the outlet and the milk conduit.

25. Milking machine according to claim 19, wherein the milking machine comprises a teat presence sensor arranged to detect the presence of a teat inside the teat cup and to provide a teat presence detection signal and the milking machine is arranged to switch off the suction pump and/or disconnect the suction pump from the teat cup on the basis of the teat presence detection signal.

26. Milking machine according to claim 19, wherein the milking pump is controllable to generate and maintain a predetermined vacuum level in the range of 35-55 kPa with an airflow in the range of 100-200 l/min.

27. Milking machine according to claim 19, wherein the suction pump is arranged to generate an airflow of at least 800 l/min, preferably at least 1000 l/min, more preferably in the range of 1000-1500 l/min.

28. Milking machine according to claim 19, wherein the suction pump is connected to the outlet via the milk conduit and the milk collecting container.

29. Milking machine according to claim 19, wherein the milking machine comprises a branching positioned in between the outlet and the milk collecting container, arranged to switch between a first and a second mode, wherein in the first mode the outlet is connected to the milk collecting container and the milking pump via the branching and in the second mode the outlet is connected to the suction pump via the branching.

30. Method of operating a milking machine according to claim 19, wherein the milking machine is arranged to repeatedly go through a teat searching phase and a milking phase,
wherein in the milking phase the method comprises:
controlling a milking pump to apply a predetermined vacuum to a milk conduit to transport milk from a teat cup via an outlet of the teat cup and the milk conduit to a milk collecting container,
and wherein in the teat searching phase the method comprises:
controlling a suction pump to generate a suction flow through the teat cup towards and through the outlet and suction pump.

31. Method according to claim 30, wherein in the teat searching phase the method further comprises
detecting presence of a teat inside the teat cup using a teat presence sensor and to provide a teat presence detection signal and
switching off the suction pump or disconnecting the suction pump from the teat cup on the basis of the teat presence detection signal.

32. Method according to claim 30, wherein the method further comprises
controlling the working speed of the milking pump during the milking phase and
controlling the suction pump to be in one of an idle state and a preferably non-regulated working state.

33. Method according to claim 30, wherein the method further comprises measuring a pressure in one of the teat cup, the outlet or the milk conduit and controlling the working speed of the milking pump in response to the measured pressure during the milking phase.

34. Method according to claim 30, wherein the method further comprises controlling the milking pump to generate a predetermined vacuum level in the range of 35-55 kPa with an airflow in the range of 100-200 l/min during the milking phase, and controlling the suction pump to generate an airflow of at least 800 l/min during the teat searching phase, preferably of at least 1000 l/min, more preferably in the range of 1000-1500 l/min.

35. Milking arrangement comprising a plurality of milking machines according to claim 19 and in particular each comprising at least one teat cup with an outlet, a milk collecting container, a milk conduit connecting the outlet of the teat cup and the milk collecting container, the milking arrangement further comprising a milking pump arranged to apply a predetermined and controlled vacuum to the milk conduit of at least one of the milking machines to transport milk, for that milking machine, from the teat cup via the outlet to the milk collecting container during the milking phase, the milking arrangement comprises at least one separate suction pump arranged to generate for at least two of the milking machines a suction flow through at least one teat cup towards and through the respective outlet during a teat searching phase of the respective milking machine, in particular the suction pump being arranged to be operatively connectible to at least one teat cup of at least two milking machines.

36. Milking arrangement of claim 35, arranged as a milking carrousel.
